(19) United States
(12) Patent Application Publication
(10) Pub. No.: US 2018/0218400 A1
(43) Pub. Date: Aug. 2, 2018

(54) CONDITIONAL PLAYING OF ADVERTISEMENTS BASED ON MONITERED USER ACTIVITY LEVELS

(71) Applicant: Jamieson Kerns, Santa Monica, CA (US)

(72) Inventor: Jamieson Kerns, Santa Monica, CA (US)

(73) Assignee: GOOGLE INC., Mountain View, CA (US)

(21) Appl. No.: 13/431,913

(22) Filed: Mar. 27, 2012

(51) Int. Cl. G06Q 30/02

(52) U.S. Cl. CPC G06Q 30/0256

(57) ABSTRACT

Systems and methods for providing an advertisement user based on monitored user activity levels and user engagement levels. A monitoring component monitors user interaction with a device at which media content is being played. In an aspect, the monitoring component monitors user engagement parameters with the media content. In turn, an analysis component can determine an activity level of a user and/or an engagement level of a user based on the monitored information. A streaming component further streams a media advertisement to the device as a function of the activity level and/or the engagement level of the user.

### TECHNICAL FIELD

This disclosure relates to providing media advertisements based in part on user activity levels and predicted user engagement with the advertisements.

### BACKGROUND

In general, advertisements are only effective if received and at least viewed and/or heard by a potential consumer or targeted individual. Often times, although a user may receive a media advertisement, he may not listen to it or view it. Further, where an in-stream advertisement is provided with the option to skip the advertisement, a viewer may not elect to skip the advertisement because he may simply not be paying attention, not because he is actually interested in advertisement. Nevertheless, despite the fact that the advertisement was not seen and/or heard by a user, the advertiser may still be required to pay a media provider for providing the advertisement.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope particular embodiments of the disclosure, or any scope of the claims. Its sole purpose is to present some concepts of the disclosure in a simplified form as a prelude to the more detailed description that is presented later.

In accordance with one or more embodiments and corresponding disclosure, various non-limiting aspects are described in connection with providing media advertisements and billing for the providing of the advertisements based in part on user interaction with the advertisements.

In accordance with a non-limiting embodiment, in an aspect, a system is provided comprising a monitoring component that monitors user interaction with a device at which media content is being played. In an aspect, the monitoring component monitors user engagement parameters with the media content. In turn, an analysis component can determine an activity level of a user and/or an engagement level of a user based on the monitored information. A streaming component further streams a media advertisement to the device as a function of the activity level and/or the engagement level of the user.

In another non-limiting embodiment, provided is a method comprising monitoring user interaction with a device at which media content is being played. The method further comprises determining an activity level of a user based on the monitored interaction, and streaming an advertisement as a function of the activity level of the user. In an aspect, the determining the activity level of the user comprises determining whether the user is either active or inactive, and wherein the streaming further comprises streaming the advertisement to the device in response to the active activity level being active, or not streaming the advertisement to the device in response to the activity level being inactive.

In yet another non-limiting embodiment a computer-readable storage medium is provided comprising computer-readable instructions that, in response to execution, cause a computing system to perform operations comprising monitoring user interaction with a device at which media content is being played. The operations further comprise determining an activity level of a user based on the monitored interaction, and streaming an advertisement as a function of the activity level of the user.

### BRIEF DESCRIPTION OF THE DRAWINGS

FIG. 1 illustrates an example non-limiting media system that facilitates that facilitates playing a media advertisement based in part on monitored user activity levels and/or engagement levels in accordance with various aspects and implementations described herein.

FIG. 2 illustrates an example of another non-limiting media system that facilitates that facilitates playing a media advertisement based in part on monitored user activity levels and/or engagement levels in accordance with various aspects and implementations described herein.

FIG. 3 illustrates an example of another non-limiting media system that facilitates that facilitates playing a media advertisement based in part on monitored user activity levels and/or engagement levels in accordance with various aspects and implementations described herein.

FIG. 4 illustrates an example of another non-limiting media system that facilitates that facilitates playing a media advertisement based in part on monitored user activity levels and/or engagement levels in accordance with various aspects and implementations described herein.

FIG. 5 illustrates an example of a non-limiting media system that facilitates that facilitates playing and billing for a media advertisement based in part on monitored user activity levels and/or engagement levels in accordance with various aspects and implementations described herein.

FIG. 6 illustrates an example of another non-limiting media system that facilitates that facilitates playing a media advertisement based in part on monitored user activity levels and/or engagement levels in accordance with various aspects and implementations described herein.

FIG. 7 illustrates an example methodology for streaming a media advertisement based in part on monitored user activity levels in accordance with various aspects and implementations described herein.

FIG. 8 illustrates another example methodology for streaming a media advertisement based in part on monitored user activity levels in accordance with various aspects and implementations described herein.

FIG. 9 illustrates an example methodology for streaming a media advertisement based in part on monitored user engagement levels in accordance with various aspects and implementations described herein.

FIG. 10 is a block diagram representing an exemplary non-limiting networked environment in which various embodiments can be implemented in accordance with various aspects and implementations described herein.

FIG. 11 is a block diagram representing an exemplary non-limiting computing system or operating environment in which various embodiments may be implemented in accordance with various aspects and implementations described herein.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

It is to be appreciated that in accordance with one or more embodiments or implementations described in this disclosure, users can opt-out of providing personal information, demographic information, location information, proprietary information, sensitive information, or the like in connection with data gathering aspects. Moreover, one or more embodiments or implementations described herein can provide for anonymizing collected, received, or transmitted data.

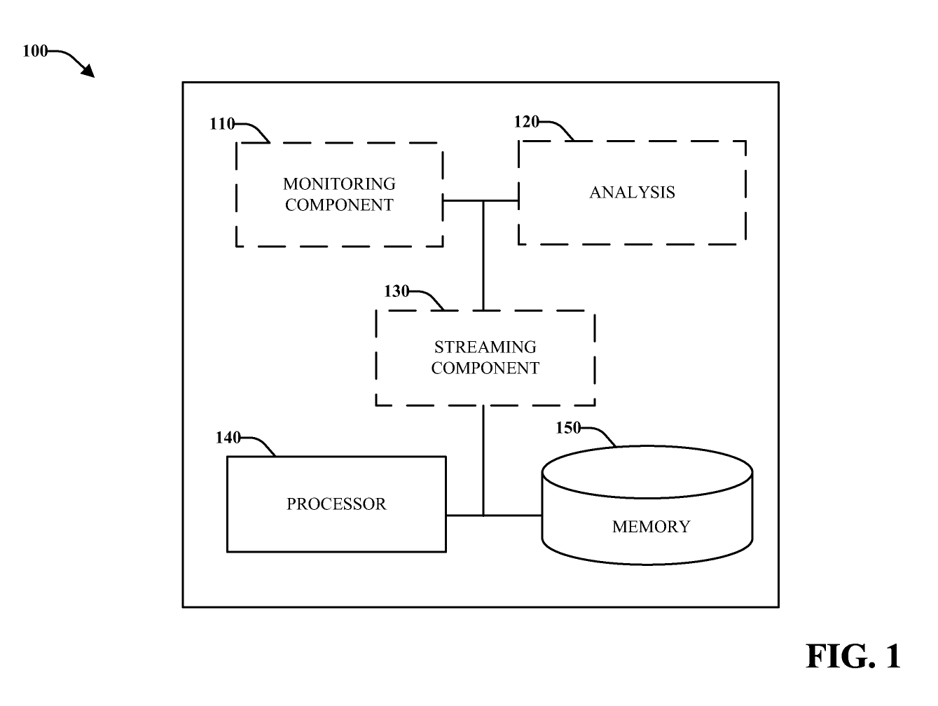

Referring now to the drawings, with reference initially to FIG. 1, a media system 100 that facilitates playing a media advertisement based in part on monitored user activity levels is presented. Aspects of the systems, apparatuses or processes explained in this disclosure can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 100 can include memory 150 for storing computer executable components and instructions. A processor 140 can facilitate operation of the computer executable components and instructions by the system 100.

In an embodiment, system 100 is a streaming media provider and can include monitoring component 110, and analysis component 120, and streaming component 130. In an aspect, a monitoring component 110 monitors user interaction with a device at which media content is being played. For example, a client device can receive media content from media system 100 via streaming component 130. Analysis component 120 determines an activity level of a user based on the monitored interaction, and streaming component 130 streams a media advertisement to the device as a function of the activity level of the user.

As used herein, the term media item or media content can include video data and/or audio data. Media items can be associated with one or more data sources that can be accessed by a client device or by a media system such as system 100 (and additional systems described in this disclosure). For example, media items can include various types of video including but not limited to movies, television, streaming television, advertisements or video games. In an aspect, a data source can include a data store storing media items and located internal to system 100. For example, memory 150 can include a data store comprising video files. In another aspect, a data source can include a data store storing media items and affiliated with a media content provider that interacts with the media system 100.

In an aspect, media system 100, (and additional systems described in this disclosure), provide media items, such as videos, to a client device (not shown). For example, media system 100 can stream media content such as a video or advertisement to a client device resulting in real-time or substantially real-time playing of the video or advertisement at the client device. A client device can include any suitable computing device associated with a user and configured to interact with or receive media content and at least play the media content. For example, a client device can include a desktop computer, a laptop computer, a smart-phone, a tablet personal computer (PC), or a PDA. As used in this disclosure, the terms “consumer” or “user” refer to a person, entity, system, or combination thereof that employs media system 100 (or additional systems described in this disclosure) via a client device. In an aspect, a client device or media system 100 (or additional systems described in this disclosure) can be configured to access and receive media items via a network such as for example the Internet, intranet, or cellular service. For example, a client device may view and interact with media items provided by system 100 (or additional systems described herein) using a browser and/or media playing software.

In an embodiment, streaming component 130 streams media items to client devices over a network using a streaming media system. For example, the streaming component 130 can employ an HTTP-based media streaming communications protocol that works by breaking the overall stream into a sequence of small HTTP-based file downloads, each download loading one short chunk of an overall potentially unbounded transport stream. For example, the streaming component 130 can employ HTTP Live Streaming (HLS). In another example the streaming component 130 can employ smooth streaming or HTTP dynamic streaming.

Streaming component 130 is configured to stream multiple videos to a same device simultaneously. In particular, streaming component 130 can stream a video to a client device and further provide the client with an in-stream advertisement. As used herein, the term in-stream is used to refer to a video streamed on a same or different media stream as an other video that is provided to a client device at a same or substantially same time as the other video. In-stream advertisements provide a platform that allows advertisers to place video ads in video content that is streamed over a network. Streaming component 130 is configured to stream video with in-stream video advertisements. In an aspect, an in-stream advertisement can be previously integrated with a primary content video and streamed by steaming component 110 with the primary content video when scheduled. In another aspect, the streaming component 130 can dynamically insert in-stream advertisements into a data stream of a primary content video. Still in yet another aspect, streaming component 130 is configured to modify remove, and or dynamically control the streaming of in-stream advertisements. As used herein, the term primary content video is used to refer to a video (or other media item), that is voluntarily and/or originally selected/requested by a user for playing. On the other hand, advertisements generally include video (or other media content) that is provided to a user in association with primary video content, at least initially without the direct request by the user.

In an aspect, an in-stream video can include a pre-roll video, a companion banner, and/or a non-linear banner. A pre-roll video is a digital video (often a 15 to 30 second advertisement) that plays in a website's video player before or in the middle of other video content. A companion banner is an Adobe Flash™ player banner that displays on a webpage while the pre-roll video is playing and remains on the page after the video has completed. A non-linear banner is an interactive Adobe Flash™ banner or static image that displays over a pre-roll video as it's playing. Non-linear banners may also disappear after the pre-roll video completes or continue through the entire content play of the other video content.

In an aspect, streaming component 130 is configured to stream media content, including in-stream advertisements, to a device in a format that allows a user of the device to interact with the actual media content. For example, streaming component 130 can stream an advertisement to a client device that is configured to be played as a pre-roll video in conjunction with a requested primary video. The advertisement can further be provided with an option to skip the advertisement upon user selection of an interactive dialogue box that initiates the skipping or ending of the advertisement. For example, an in-stream advertisement that is thirty seconds long may be configured to enable a user to select an option to skip the advertisement after viewing the first five seconds of the advertisement. However, in addition to being configured to be played and skipped, streaming component 130 can stream an advertisement that can further be configured to be re-played, paused, fast-forwarded, re-winded, and/or shared.

For example, the streaming component 130 may stream an advertisement to a device employing a media player that enables playing and interaction with the advertisement. The advertisement can further be streamed by streaming component 130 in a format that allows the advertisement to be played in real-time or substantially real-time, paused, re-played, fast-forwarded, re-winded, and shared. Upon receiving the advertisement at the device, a user of the device may employ the media player to play the first ten seconds of the advertisement, then rewind and replay the first ten seconds, then jump ahead or fast-forward the advertisement and play the last ten seconds, then rewind the advertisement back to the beginning and pause the advertisement prior to re-playing, and etc. The user may desire to interact with the advertisement in any manner in order to gain an understanding of the subject matter of the advertisement prior to watching the entire advertisement or re-watch parts of the advertisement for educational or entertainment value. Regardless of the reasons for interacting with the advertisement, the streaming component 130 is configured to stream advertisements (and other media content) in a format that allows for such interaction.

Monitoring component 110 monitors a variety of factors that can be employed by analysis component 120 to determine at least an activity level of a user and an engagement level of a user. As used herein, an activity level of a user relates to a degree in which a user if physically interacting with his device. Engagement level relates to a degree in which a user's attention is attracted to and held by, media content streamed to a client device.

In general, advertisements are only effective if received and at least viewed and/or heard by a potential consumer or targeted individual. Often times, although a user may receive a media advertisement, the user may not listen to it or view it. Further, where an in-stream advertisement is provided with the option to skip the advertisement, a viewer may not elect to skip the advertisement because he may not be paying attention. Nevertheless, despite the fact that the advertisement was not seen and/or heard by a user, the advertiser may still be required to pay a media provider for providing the advertisement. It can be assumed that owners of advertisements will be more inclined to pay for advertising space with streaming media providers if the owner of the advertisement can at least in part ensure that their advertisement is actually viewed and/or heard by a user. It can further be assumed that owners of advertisements may pay a premium for an advertisement provided to a user that not only viewed and/or listened to the advertisement, but further engaged with and interacted with the advertisement in a manner that indicated the user was clearly interested in the advertisement. In an aspect, systems and methods disclosed herein facilitate providing advertisements to user's who are likely to be engaged with the advertisement and charging for the providing as a function of user engagement.

With the above assumptions in mind, in an embodiment, the monitoring component 110 is configured to monitor user interaction with a device at which media content is being played. In turn, the analysis component 120 can determine an activity level of a user and the streaming component 130 can provide the advertisement based on the activity level. For example, where a user has not interacted with his device for fifteen minutes, the analysis component 120 may determine that the user is inactive. As a result, the streaming component 130 can skip streaming of a scheduled advertisement. In an aspect, users can opt-out of providing personal information in connection with monitoring aspects. Further, users can opt-out of one or more aspects of monitoring of user interaction with a device at which media content is being played.

In an aspect, user interaction with a device at which media content is being played includes physical user interaction with the device via an input or reception mechanism. For instance, user interaction with a device at which media content is being played includes mouse movement, touch pad interaction, and keyboard activity effectuated by a user. For example, the monitoring component can monitor usage of a pointing device, including usage resulting in movement of a mouse or cursor and clicking of a mouse or cursor. Additional input mechanisms can include user input via audio input devices, camera input devices, and other sensor reception/input devices that include but not are limited to: acoustic sensors, vibration sensors, chemical sensors, cameras, motion sensors, thermal sensors, magnetic sensors, motion sensors, optical sensors, and proximity sensors. In an aspect, user interaction includes activity that results in reaction in a graphical user interface that is direct result of a physical action by a user. For example, user interaction with a device can include movement of a cursor as a result of mouse movement, keystrokes or keyboard activity, stylus movement, finger movement with respect to a touch screen interface, or verbal/audio input commands. Still in yet another aspect, in order to detect user interaction with a device, the monitoring component 110 can monitor hardware or software interrupt signals.

The monitoring component is configured to monitor a variety of factors associated with user interaction with his device when employing the device to use system 100 (and additional system described herein). In particular, the monitoring component 110 can monitor timing of user interaction, frequency of user interaction, duration of user interaction, and type of user interaction. In an aspect, monitoring component 110 is configured to track user interaction with a device employing system 100 in order to track a last event of user activity or interaction at the device. In an aspect, monitoring component 110 can track all user interaction with a device regardless of the applications running at the device. In another aspect, monitoring component 110 can track user interaction with a device at which media content is being played. For example, a device may employ a media player to play a video streamed from system 100 and monitoring component 110 can track user interaction with the device when the video is being streamed thereto. For example, the monitoring component 110 can monitor user interaction as a video is being streamed to a device prior to the playing of an advertisement, during the playing of the advertisement, and following the playing of the advertisement. According to this aspect, the monitoring component 110 can begin tracking user interaction with a device in response to media content being streamed thereto by streaming component 130. The monitoring component can further continue to monitor user interaction while the media content is streamed to the device.

Still in yet another aspect, the monitoring component 110 can initiate tracking of user interaction with a device in response to access of media system 100 or access of a website, program, application or other system that employs system 100. According to this aspect, the monitoring component 110 can begin monitoring user interaction with his client device when the user opens a media streaming website in a browser and navigates the website without receiving streamed media content. Similarly, the monitoring component 110 can track all user interaction at a client device or user interaction specifically associated with a media website, program, application, and/or other system that employs system 100. For example, monitoring component 110 can be configured to track user activity associated with webpage at which a media player is running or playing media content.

In an embodiment, the monitoring component 110 can track information pertaining to the type of activity, the motivations for the activity, or the effects of the activity and the time of user activity. For example, the monitoring component 110 may track coordinates of mouse movements and timestamps for the coordinates, or the pressing of a key resulting in the fast-forwarding of a video. In furtherance of this example, the monitoring component 110 can monitor whether a user clicks on a player or another dialogue box. In another embodiment, the monitoring component 110 tracks only time occurrences of user interaction or user activity. According to this embodiment, any additional information regarding the type of activity, the motivations for the activity, or the effects of the activity is not tracked. For example, the monitoring component 110 can track only information pertaining to a timestamp of the last mouse or keyboard action.

In an aspect, the monitoring component 110 can track user activity within pre-defined time periods. For example, the monitoring component 110 can apply a temporal resolution of about 500 ms to about 1000 ms when tracking user activity. According to this example, multiple activities within the predefined time period, such as 1000 ms, can be ignored. The monitoring component 110 can instead collectively note that user activity occurred within the time period. Further, in an embodiment, the monitoring component can be configured to track user interaction indicative of deliberate action by a user. For example, the monitoring component 110 can be configured to disregard small mouse movement associated with mouse drift. For instance, the monitoring component can ignore mouse movements with low velocity (pixels per second), which are often indicative of mouse drift or the mouse moving slowly with no user interaction.

In addition to user device interaction or user activity, in another embodiment, the monitoring component 110 is configured to monitor parameters related to and indicative of, user engagement with media content being played at a client device. As used herein, the term user engagement relates to persistent attraction of a user's attention to media content. In an aspect, the monitoring 110 monitors user engagement factors associated with user engagement in media content, such as a primary video being streamed to a client device as well as an associated in-stream media advertisement. For example, the monitoring component 110 may monitor user engagement parameters of a user watching a primary video that includes an in-stream advertisement, prior to the playing of an advertisement. In another aspect, the monitoring component 110 can monitor user engagement factors associated with user engagement in an advertisement being streamed to and played at a client device. For example, the monitoring component 110 can monitor user engagement with an advertisement while it is being played at a client device.

In an aspect, user engagement parameters or factors can include information relating to user interaction with a device at which media content is being played, as discussed above. For example, user activity information, (especially information related to type of interaction, duration of interaction, motivations for the interaction and results of the interaction) can be employed by analysis component 120 to determine both a user's activity level and a user's engagement level with media content. In addition, user engagement parameters or factors can relate to user interaction with the media content itself, and additional or secondary factors related to a user's interaction with a device at which media content is being played. User interaction with media content itself (including primary videos selected by a user and advertisements associated therewith) can include but is not limited to, viewing or playing the media content, re-playing the media content, pausing the media content, fast forwarding the media content or re-winding the media content. Secondary factors related to a user's interaction with the device at which an media content is streamed/played can include but are not limited to: device context, a user's physical positioning and/or posture, a user's visual direction, device operating parameters, volume of the player in which an advertisement is being played, the size of the window of the player in which the advertisement is being played in the graphical user interface (GUI) of the device, the number of open windows in the GUI of the device, or the location of the player application window with respect to other open windows in the GUI of the device.

With respect to user interaction with media content, in an aspect, the monitoring component 110 can monitor the duration of user interaction with media content. Duration of user interaction with media content can include the cumulative time period in which a user interacts with media content. For example, the monitoring component can monitor the playing time of a video, the re-winding time, the fast-forwarding time, and/or or the time paused. According to this example, the duration of interaction with the media content would include the total time spent playing the video, re-winding the video, the fast-forwarding the video and pausing the video. In another aspect, the monitoring component 110 can monitor the type of user interaction and/or the quality of user interaction with media content. For example, the monitoring component 110 can monitor the duration of time a video is played, when a video is re-winded and to what point, when a video is fast forwarded and to what point, what sections of the video are played and what sections are replayed, or what sections are paused and when they are paused, and etc. Further, the monitoring component 110 can monitor the frequency of user interaction with media content. For example, the monitory the number of times a user presses pause or rewind over the duration of interaction with the media content.

With respect to secondary factors related to a user's interaction with the device at which media content is streamed, in an aspect, the monitoring component 110 can monitor device context. Device context can include but is not limited the physical location of a device, other devices near a device at which media content is being played, and time of day. Other secondary factors can relate to a user's physical presence with respect to a device at which media content is being streamed. For example, the monitoring component 110 can monitor the location of a user with respect the device, the location of a user's hand with respect to an interfacing tool such as a mouse, keyboard or touchpad. In another example, the monitoring component 110 can monitor a user's posture, and/or the direction of a user vision. According to this aspect, the monitoring component 110 can utilize one or more sensory device associated with a user device to determine a user's physical presence. For example, the monitoring component 110 can utilize a camera, an acoustic sensor, an optical sensor, or a thermal sensor, that is associated with a client device.

In another aspect, the monitoring component 110 can monitor secondary factors relating to device operating parameters, including but not limited to screen size, picture quality, and network connection efficiency. In another aspect, the monitoring component 110 can monitor the volume of the player in which media content is being played, including when the volume of the player is turned off or muted. Still in other aspects, the monitoring component 110 can monitor the size of the window of the player in which media content is being played in the graphical user interface (GUI) of the device. For example, the monitoring component 130 can monitor if a window is minimized or maximized, as well as the sizing dimensions of the window. Similarly, the monitoring component 130 can monitor the number of open windows in the GUI of the device, or the location of the player application window with respect to other open windows in the GUI of the device. For example, the monitoring component 110 can monitor whether the player application window in which media content is being played is obscured by another open window and to what degree.

Referring back to FIG. 1, analysis component 120 determines an activity level of a user and/or an engagement level of a user based on monitored information. The analysis component 120 can determine an activity level of a user based on monitored user interaction with a device employing system 100 (and additional systems described herein). In an aspect, activity levels can be predefined in memory 150 and relate to a duration of time between user device interaction events or the last time of user activity. For example, where a user last interacted with his device (as indicated by monitored information) 500 ms prior to the determination of an activity level, the analysis component 120 may determine that a user is highly active, whereas where a user last interacted with his device 5 minutes prior to the determination of an activity level, the analysis component 120 may determine that a user is less active. In an aspect, the analysis component 120 can apply two activity levels, active and inactive. According to this aspect, the analysis component 120 can determine a user as active if a last time of user activity is within a predetermined time period threshold of X seconds or minutes, where X is an integer. Similarly, the analysis component 120 can determine that a user is inactive if a last time of user activity exceeds a predetermined time period threshold of X seconds or minutes, where X is an integer. In additional aspects, the analysis component 120 can apply multiple activity levels. For example, a last time of user activity at 500 ms can be defined as a first activity level, a last time of user activity at 1 minute can be defined as a second activity level, a last time of user activity at 2 minutes can be defined as a third activity level, and etc.

Still in yet another aspect, an activity level can account for a duration and/or frequency of user interaction with a device employing system 100 over a predefined period of time. For example, the analysis component 120 may analyze set a timeframe of X seconds or minutes. The analysis component can select a time frame for example of X seconds or minutes prior to a point of a scheduled in-stream advertisement, or select a time frame that includes the initial access of a website employing media system 100. For example, the analysis component 120 may analyze the frequency of user activity (as determined by the average time separation between occurrences of user activity) in a five minute period prior to the playing of a scheduled in-stream advertisement. The frequency of activity can further relate to an activity level.

In an aspect, the analysis component 120 can be directed by streaming component 130 (or system 100 in general), to determine an activity level of a user prior to the streaming or playing of an advertisement at a client device. For example, where a primary video includes an in-stream advertisement, the analysis component 120 can be configured to determine an activity level of a user prior to the time at which the advertisement is to be played. In another aspect, the analysis component can be configured to determine user activity level in a continuous or scheduled manner, regardless of whether an advertisement is scheduled. According to this aspect, the analysis component can essentially track user activity levels associated with device usage when searching for media content and when playing media content. In another aspect, the analysis component 120 can be configured to determine an activity level of a user during the playing of an advertisement. According to this aspect, the analysis component 120 can determine an activity level at various times during the playing of an advertisement. For example, the analysis component 120 may determine a user activity level at the beginning of the playing of an advertisement and/or after the advertisement has played for X amount of time, where X is an integer.

The analysis component 120 can also analyze information monitored by monitoring component 110 to determine an engagement level of a user with media content being streamed to a client device. The analysis component 120 can determine an engagement level of a user with respect to any media content being streamed to a client device, including media content voluntarily selected to be viewed by a user (e.g. primary media content), and media advertisements. For example, a user engagement level with primary media content prior to the playing of a media advertisement can be utilized by system 100 to decide whether or not to stream the advertisement or not.

User engagement with media content can account for both qualitative and quantitative aspects of monitored information, including monitored user interaction with a client device, monitored user interaction with media content being streamed thereto, and secondary factors associated with user interaction with a client device. In an aspect, the analysis component 130 may apply predetermined threshold parameters stored in memory 150 relating user interaction activity with a device at which media content is being streamed, secondary factors related to user interaction activity, and user interaction with the media content itself, to engagement levels. For example, the analysis component 120 can apply one or more algorithms that relate activity levels, type of user interaction with a device at which media content is being played, and quality and quantity of user interaction with the media content itself, to an engagement level. For example, with respect to user interaction with media content, engagement levels can be predefined by one or more algorithms that account for quantitative factors, such duration of user interaction with media content, and qualitative factors, such as viewing of key or specific sections of media content. In another example, the analysis component 120 may determine (via one or more algorithms defined in memory 150) that a user who has a player window playing an advertisement in a minimized format with the volume muted is a disengaged user, or a user with an engagement level of zero. Still in yet another example, the analysis component may apply a greater “engagement” weight to an action of clicking on a player as opposed to clicking on a dialogue box unaffiliated with the player.

In an aspect, the analysis component 120 can apply a point based system to determine an engagement level of a user with respect to media content, where various predefined parameters are associated with weighted point values. For example, a high activity level can be associated with a first point value, clicking or pointing to objects within the player may be associated with a second point value, viewing of a specific section can be associated with another point value, and volume of the player can be associated with yet another point value and etc. In an embodiment, the analysis component 120 can apply two engagement levels equating to either an engaged user or a disengaged user. In another aspect, the analysis component 120 can apply a plurality of engagement levels. For example, the analysis component 120 may determine a score to associate with a user viewing media content that accounts for his engagement level with the content. For instance, a user who is associated with a score of zero can be considered completely disengaged while a user with a score of ten could be considered highly engaged. It should be appreciated that any scoring system relating user engagement to monitored information can be employed by system 100. For example, scoring can be based on limited set of levels or based on percentages.

Streaming component 130 is configured to stream media content to a client device. In an embodiment, streaming component 130 is configured to stream media content to a client device, (for real-time or substantially real time playing of the media content), as a function of a user's activity level and/or engagement level. As a result, the streaming component 130 can facilitate streaming of advertisements to active and/or engaged viewers. In particular, the streaming component 130 can be configured to stream an advertisement, such as an in-stream advertisement, as a function of user activity level and/or engagement level. In an aspect, the streaming component 130 can stream an advertisement in response to a user's activity level or engagement level, prior to the streaming of the advertisement, being determined as above a predetermined threshold. For example, if the analysis component 120 determines that a user's activity level is inactive or that a user is disengaged with respect to a primary video, the streaming component 130 can forgo streaming of a scheduled advertisement. In essence, the streaming component 130 can facilitate automatic skipping of scheduled advertisements when viewers are not active or most likely to be disengaged with the advertisement. Similarly, if the analysis component 120 determines that a user's activity level is active and/or a user is engaged, the streaming component 130 can proceed with streaming of a scheduled advertisement.

In another example, the analysis component 120 may determine that a user's activity level or engagement level regarding streamed media content being played at the user's device, as monitored over a period of time, is mildly active or of a low engagement level. The analysis component 120 may further determine when a spike in activity and/or engagement occurs based on monitored user interaction (e.g. when the user's activity level and/or engagement level increases above a predetermined threshold). In turn, the streaming component 130 can be configured to insert an advertisement (e.g. stream an unscheduled advertisement) in response to the increase in activity level or engagement level. In another aspect, the streaming component 130 can be configured to insert an advertisement in response to an activity level or engagement level reaching a pre-determined threshold. For example, the streaming component can be configured to stream an advertisement when a user's activity level reaches 75%.

Still in yet another aspect, the streaming component 130 can be configured to stream a media advertisement to completion or less than full completion based on a user's activity level and/or engagement level. For example, the streaming component 130 may stream an advertisement to full completion when a user's activity level and/or engagement level prior to the playing of the advertisement and/or during the playing of the advertisement, is above a predetermined threshold. For instance, the analysis component 120 may determine a user's activity level and/or engagement level with respect to an advertisement just prior to the end of the advertisement or just prior to a billable timeframe marker. (A billable timeframe marker can represent a point in the playing of the advertisement where if passed, results in a billable event associated with the providing of the advertisement. For example, if a user watches 30 seconds or more of an advertisement, the media provider may charge for providing the advertisement). The streaming component 130 can further be configured to stream an advertisement to completion if the user's activity level or engagement level just prior to the end of the advertisement or just prior to a billable timeframe marker is above a predetermined threshold. Similarly, if the user's activity level or engagement level just prior to the end of the advertisement or just prior to a billable timeframe marker is below a predetermined threshold, the streaming component 130 can stop the streaming of the advertisement at that point. In other words, where the advertisement comprises N number of seconds, the streaming component 130 can stream the advertisement for a predetermined period of time N>M seconds in response to the activity level and/or engagement level, being determined as below a predetermined threshold, wherein N and M are numbers.

In another embodiment, the streaming component 130 can pause streaming an advertisement at the N−M second mark in response to a user's activity level and/or engagement level being below a predetermined threshold. For example, the streaming component can pause the advertisement just prior to the end or just prior to a billable timeframe marker. The streaming component can further present the user with a prompt to attempt to re-engage the user at this time. For instance, the streaming component 130 can present a prompt that allows the user to select to continue playing the advertisement or skip the advertisement. In another aspect, the streaming component 130 can present a prompt that requires the user to watch the remainder of the advertisement prior to playing other media content, such as a primary video selected by the user. Still in yet another aspect, the streaming component 130 can present a prompt asking the user to rate the advertisement.

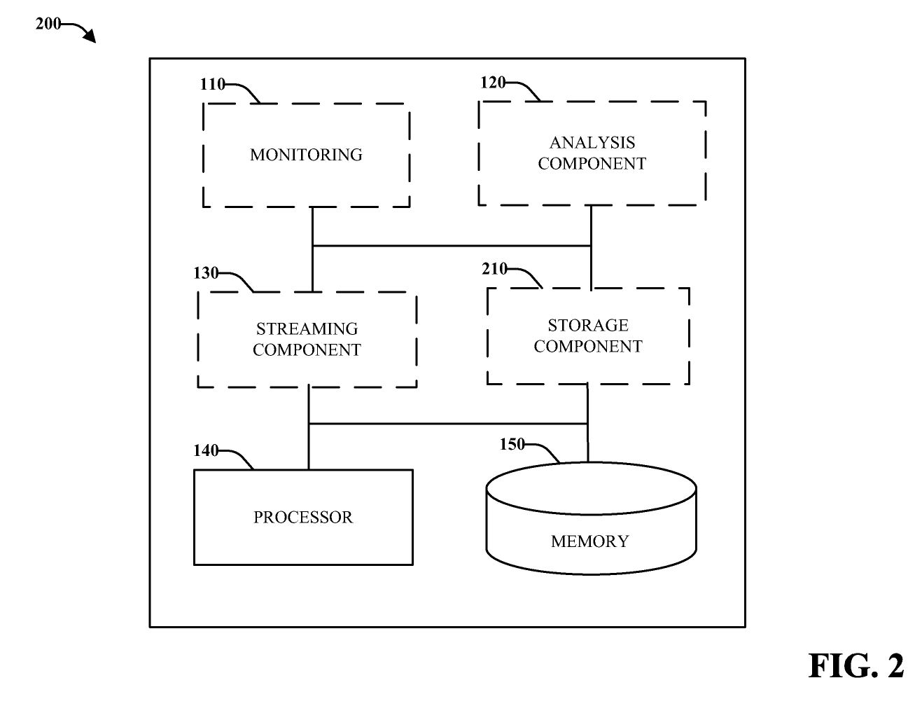

Referring now to FIG. 2, presented is another exemplary non-limiting embodiment of a media system 200 that facilitates providing media advertisements and billing for the providing of the advertisements based on user interaction with the advertisements. System 200 can include a storage component 210 that stores monitored information. In an aspect, storage component 210 stores monitored information indicating user activity or user interaction with the device at which the media content is being played. In another aspect, the storage component 210 stores monitored information indicating user interaction with an media content, including advertisements. The storage component 210 can further store any information monitored by the monitoring component, including information pertaining to user engagement with media content. In addition, the storage component can store determinations and inferences made by system 100 (and additional system described herein), as well as factors which facilitate the respective determinations and inferences. Further, although storage component 210 and memory 150 are depicted as internal to system 200, in an aspect, storage component 210 and/or memory 150 can be provided external to system 200 and made accessible to system 200 via one or more network connections.

Regarding user interaction with a device at which media content is being played or user interaction with a device employing system 100, in one embodiment, the storage component 210 merely stores timestamps of user interaction or user activity. In particular, the storage component 210 does not store personally identifiable information associated with user activity, such as the type of activity or the results of the activity. For example, the only information stored about user activity is the timestamp of the last mouse or keyboard action, and no information about the mouse coordinates or keys pressed is persisted in any way. In an aspect, the storage component 210 can comprises of local unshared memory that is a associated with a secured cookie employed by system 100.

In an embodiment, the storage component 210 can store multiple timestamps associated with user activity over a period of time. According to this embodiment, the monitoring component 110 can be configured to collect user activity continuously or in a scheduled manner. For example, the monitoring component 110 may be configured to detect user activity every 500 ms or every second. Similarly, the monitoring component can be configured to collect user engagement parameters continuously or in a scheduled manner. As a result, the storage component 210 can store a log of user activity and/or user engagement levels with respect to time which can be employed by analysis component to monitor user activity levels and/or engagement levels respectively. For example, the analysis component 120 can observe graphical information indicating a user's activity level over time to determined increases and decreases in activity levels over time. In turn, the streaming component 130 can stream an advertisement when a user's activity level and/or interest level spikes in accordance with preconfigured thresholds.

In another embodiment, the storage component 210 can also store information associated with a user, such a user profile information and/or user usage history in association with media system 200. For example, user profile information can identify a user and indicate a user's media preferences, a user's demographics, a user's age, a user's profession, a user's schedule, and any other type of information which may influence a user's interest in a media advertisement in general or under a particular context. Usage history for a user with respect to media system 200 can include a track record of a user's interaction with advertisements as well as a track record of secondary factors related to user engagement with an advertisement.

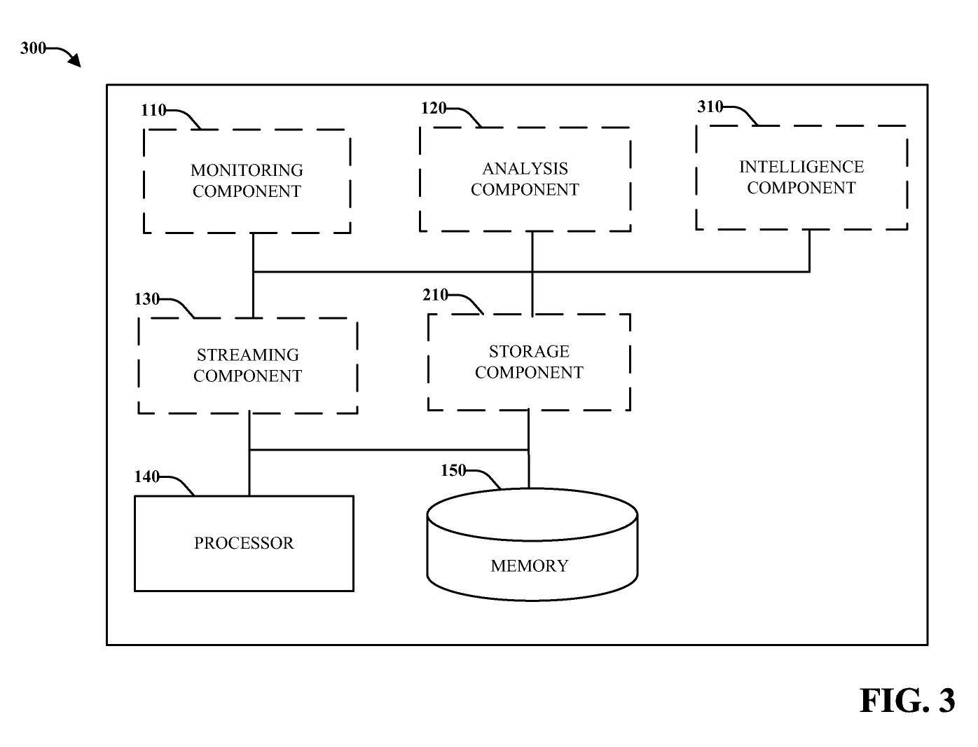

Referring now to FIG. 3, presented is another exemplary non-limiting embodiment of a media system 300 that facilitates playing a media advertisement based in part on monitored user activity levels and/or engagement levels. System 300 can include intelligence component 310. In an aspect, intelligence component 310 can aid analysis component in determining user engagement and/or interest media content. In another aspect, intelligence component 310 can facilitate inferring or determining patterns in user interaction/engagement with media content.

Intelligence component 310 can facilitate making inferences or determinations in connection with determining user interest/engagement with media content, including advertisement. For example, intelligence component may employ learned associations between playing time, playing of specific sections of an advertisement, user preferences, player volume level, player window location with respect to the GUI of a user device, user posture, and user visual direction, in order to infer user engagement level in media content. In order to provide for or aid in the numerous inferences described in this disclosure, intelligence component 310 can examine the entirety or a subset of data to which it is granted access in order to provide for reasoning about user engagement with media content. Intelligence component 310 can be granted access to any information associated with media system 300 (and additional system described herein), including information logged and/or monitored by system 300 (via monitoring component 120) and stored in memory 150, as well as accessible extrinsic information. For example, intelligence component 310 can employ monitored information held in storage component 210, user preference and usage history information in held in storage component 210, and parameters related to user interaction and activity levels as well as secondary factors and user engagement levels, stored in memory 150. Intelligence component 310 can further employ extrinsic information related to current events and extrinsic information describing streamed media content

Intelligence component 310 can perform inferences can to identify a specific context or action, or to generate a probability distribution over states, for example. The inferences can be probabilistic—that is, the computation of a probability distribution over states of interest based on a consideration of data and events. An inference can also refer to techniques employed for composing higher-level events from a set of events or data. Such inference can result in construction of new events or actions from a set of observed events or stored event data, whether or not the events are correlated in close temporal proximity, and whether the events and data come from one or several event and data sources. Various classification (explicitly or implicitly trained) schemes or systems (e.g., support vector machines, neural networks, expert systems, Bayesian belief networks, fuzzy logic, data fusion engines, etc.) can be employed in connection with performing automatic or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used in this disclosure also is inclusive of statistical regression that is utilized to develop models of priority.

In an embodiment, analysis component 120 and/or intelligence component 310 can employ information contained in storage component 210 to determine patterns in user activity and user engagement. For example, the analysis component 130 may determine that when a particular advertisement is provided as an in-stream advertisement with a primary video entitled “XYZ” and when viewed on a display screen with high resolution, the advertisement is associated with high engagement levels. The analysis component 130 and/or intelligence component 310 can further analyze and/or infer characteristics of media content that may have an influence on a pattern associated with high activity and/or interest levels. For example, the intelligence component 310 may attribute an increase in activity levels and/or interest levels with respect to a particular video to a funny content piece or jaw dropping stunt at a specific time frame. System 300 can further facilitate selling such business intelligence information gathered in response to analysis of user activity and engagement to producers of media content and advertisements, as well as marketing companies.

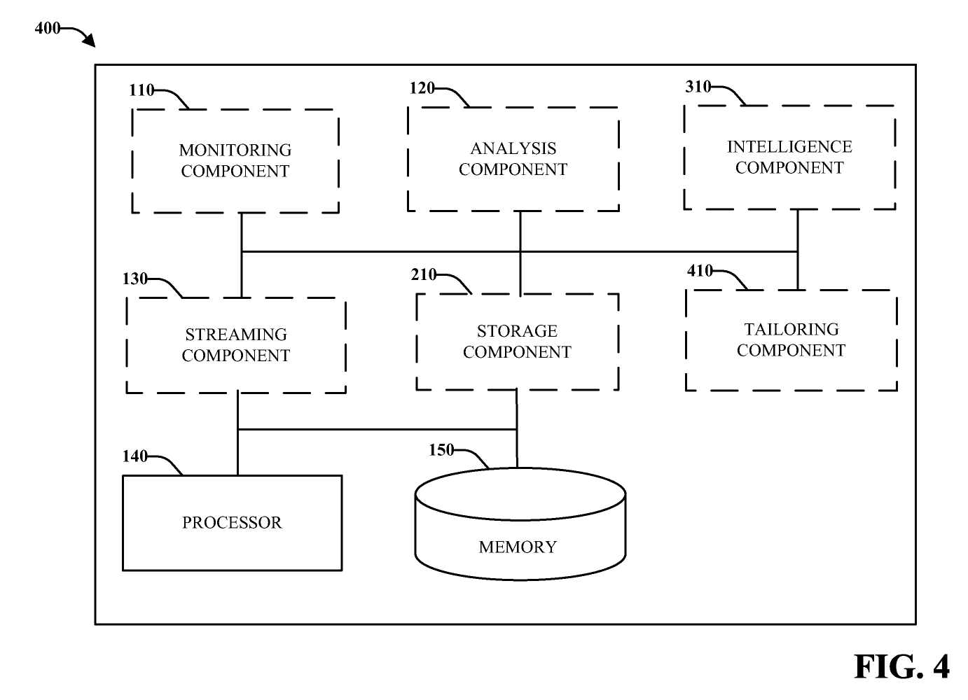

Referring now to FIG. 4, presented is another exemplary non-limiting embodiment of a media system 400 that facilitates playing a media advertisement based in part on monitored user activity levels and/or engagement levels. System 400 can include tailoring component 410. In an aspect, tailoring component 410 is configured to modify what advertisements are provided to a user based on at least user activity levels and/or user engagement levels. According to this aspect, the tailoring component 410 may dynamically determine an advertisement to provide to a user based on his engagement or activity level during the streaming of a primary video. For example, a primary video may not include any advertisements associated therewith or may have advertisements associated therewith that can be modified, interchanged, or skipped over. System 400 can further have access to a plurality of different advertisements stored in memory or an external data store. The tailoring component 410 can further choose to insert an advertisement, replace a scheduled advertisement, or modify a schedule advertisement, based on a user's engagement level and/or activity level. For example, the tailoring component may determine that a user who has a low activity level with respect to a primary video should be woken up with a high intensity advertisement. Accordingly, the tailoring component can select a high intensity advertisement to insert into the primary video.

In another aspect, in addition to a user's activity level and/or engagement level, the tailoring component 410 can also dynamically select an advertisement to provide to a user based on the general content of the primary video, the current content of the primary video, and the user profile information. For example, the tailoring component 410 may employ intelligence component 310 to make inferences regarding the type of advertisement that would capture the interest of a drifting viewer based on the user's preferences and the what actions are occurring in the primary video. For example, a user may enjoy action films (as indicated in user profile information). The user may further be watching an action film, yet at a specific point in time during the film, there is a lull in the action. At this point in time, the tailoring component 410 may determine that the users' engagement level has lowered. In turn the tailoring component 410 may select a high action type of advertisement to stream to the user during the lull period to try and recapture the users' attention while further ensuring a likelihood that the user will pay attention to the advertisement.

In another aspect, tailoring component 410 is configured to dynamically modify display features associated with streamed media content as a function of at least user activity and/or engagement levels. In similar aspect, the tailoring component 410 can dynamically modify display features associated with streamed media content as a function of any monitored information. For example, the tailoring component 410 can dynamically modify the size of a player window with respect to the GUI of a user device, the location of a player window with respect to the GUI of a user device, the volume the player playing the media content, the resolution of the player, and etc. The tailoring component 410 can modify display features of primary video content as well as advertisements.

In an aspect, the tailoring component 410 can modify display features of an advertisement in response to user activity levels and/or user engagement levels associated with a primary video. For example, the tailoring component 410 may determine that a user if viewing a primary video in a minimized screen and has a low engagement level and/or activity level prior to the streaming of a scheduled in-stream advertisement. In turn, the tailoring component 410 may cause the in stream advertisement to play in a new player window that is maximized or to maximize the original player window at the time of the scheduled advertisement. In another aspect, the tailoring component 410 can modify display features of an advertisement in response to user activity levels and/or user engagement levels associated with the advertisement. For example, the tailoring component 410 may cause an advertisement to be played in three dimensions and at an increased volume when a users' engagement level in the advertisement is low.

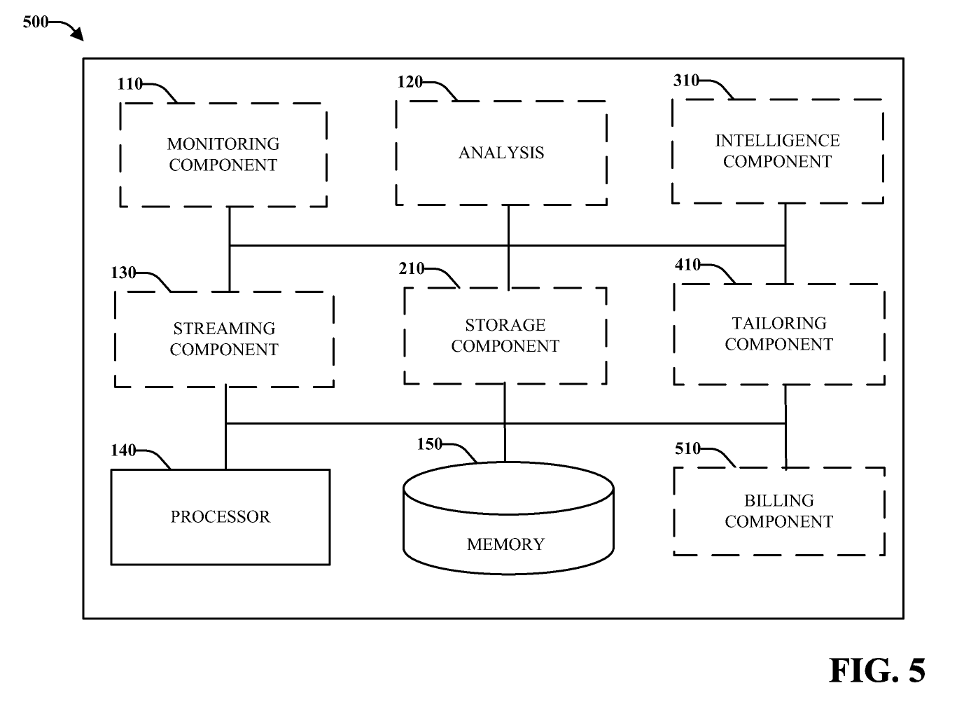

With reference to FIG. 5, presented is another exemplary non-limiting embodiment of a media system 500 that facilitates providing media advertisements and billing for the providing of the advertisements based on user activity levels and/or engagement levels. System 500 can include a billing component 510 that generates a bill for proving an advertisement to full completion or beyond a billable event marker. In another aspect, billing component 510 is configured to generate a bill for providing of an advertisement based on a user activity level and/or user engagement level with respect to the playing of the advertisement.

According to this aspect, the analysis component 120 and/or inference component 310 can determine a user's activity level and/or engagement level as a user is viewing an advertisement. For example, the analysis component 120 may determine that a user viewed an advertisement with an engagement level of 60 percent. The billing component 510 can further be configured to determine billing levels or billing rates for viewed advertisement based on user activity level and/or engagement level. For example, the billing component 510 may apply a charge of 0.6 cents for an advertisement viewed at an activity level and/or engagement level of 60 percent. In order to determine billing levels, the billing component can apply predefined parameters (such as a look-up table) associating billing levels with activity levels and/or engagement levels stored in memory 150.

In an aspect, in response to generating a bill, the billing component 510 can send the bill to a designated payee for the bill. For example, the billing component 510 can send an electronic or paper invoice to the owner or sponsor of the advertisement. In another aspect, the billing component 510 may accumulate charges for providing advertisement event over a period of time and generate a bill or invoice over predetermined increments of time. For example, the billing component 510 may generate a bill once a week, once every two weeks, once a month, and etc. that accounts for the number of times the advertisement was streamed to completion or beyond a billable event marker during the period of time.

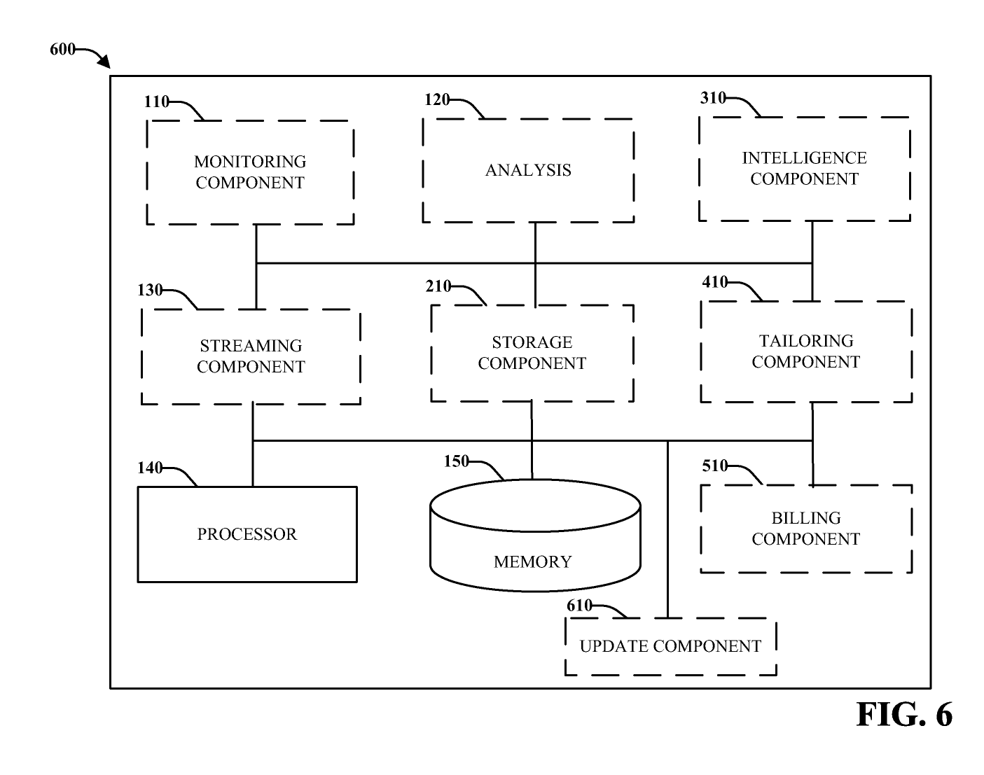

Referring now to FIG. 6, presented is another exemplary non-limiting embodiment of a media system 600 that facilitates playing a media advertisement based in part on monitored user activity levels and/or engagement levels. System 600 can update component 610. In an embodiment, update component 610 is configured to update timestamps in storage component 210 associated with monitored user device interaction or user activity levels. In particular, in an aspect, storage component 210 can store multiple timestamps generated for user activity over time. Update component 610 is configured to remove old timestamps from memory or storage component 210 over time to ensure that only recent activity of a user is stored.

For example, the update component 610 can ensure that only timestamps for the last or most recent event of user activity is stored in storage component 210. Thus each time a new event of user activity occurs, the update component 610 is configured to generate a new timestamp for the new activity and replace the preceding timestamp with the new timestamp. In another aspect, the update component can apply expiration times to the last or most recently stored event of user activity. In particular, the update component 610 can apply limit to timestamps which cause them to expire after a predetermined period of time such that a user does not appear inactive when returning to a website or webpage based on a previously stored timestamp. For example, a last activity timestamp can expires after 6 hours, so if the timestamp stored in a cookie associated with storage component 210 is more than 6 hours old, the system treats the user as active and refreshes the cookie.

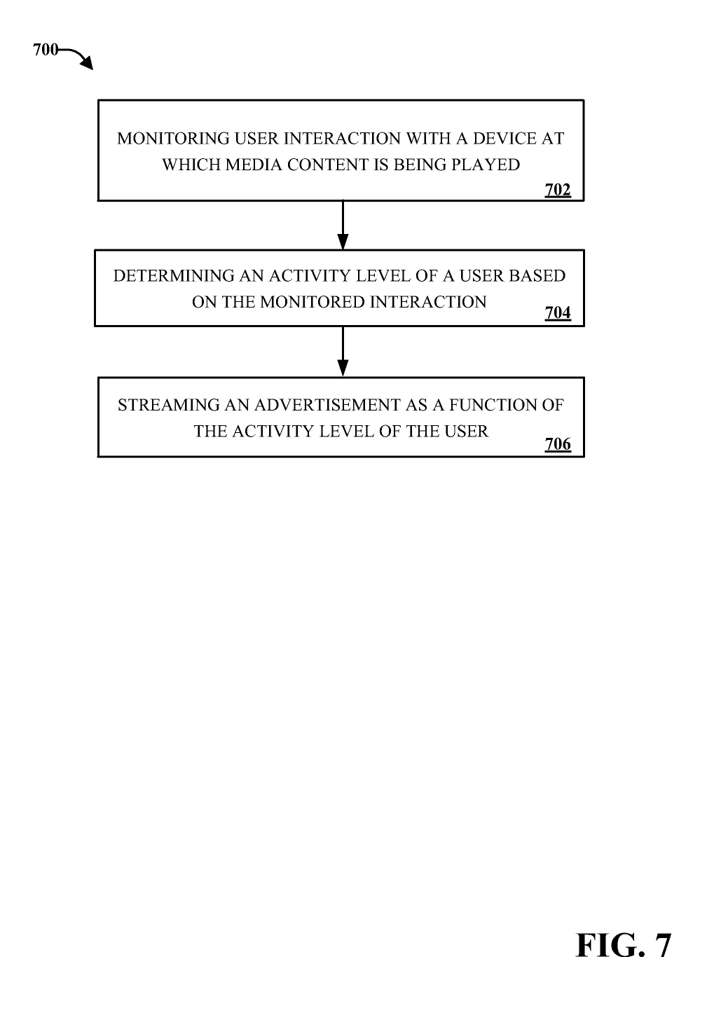

FIGS. 7-9 illustrates methodologies or flow diagrams in accordance with certain aspects of this disclosure. While, for purposes of simplicity of explanation, the methodologies are shown and described as a series of acts, the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be appreciated that the methodologies disclosed in this disclosure are capable of being stored on an article of manufacture to facilitate transporting and transferring such methodologies to computers or other computing devices.

Referring now to FIG. 7, presented is a flow diagram of an example application of systems disclosed in this description accordance with an embodiment. In an aspect, exemplary methodology 700, a media system is stored in a memory and utilizes a processor to execute computer executable instructions to perform functions. At 702 user interaction with a device at which media content is being played is monitored (e.g. using monitoring component 110). For example, the monitoring component 110 can monitor mouse movement or keyboard strokes effectuated by a user. At 704, an activity level is determined based on the monitored interaction (e.g. using analysis component 120). At 706, an advertisement is streamed as a function of the activity level of the user (e.g. using streaming component 130).

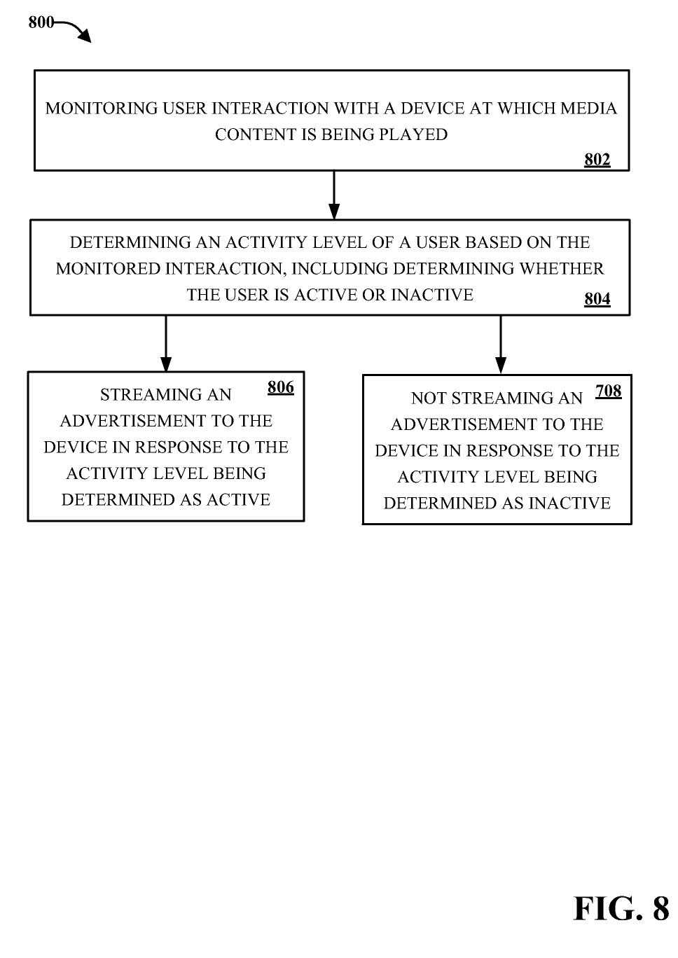

Referring now to FIG. 8, presented is another flow diagram of an example application of systems disclosed in this description accordance with an embodiment. In an aspect, exemplary methodology 800, a media system is stored in a memory and utilizes a processor to execute computer executable instructions to perform functions. At 802 user interaction with a device at which media content is being played is monitored (e.g. using monitoring component 110). For example, the monitoring component 110 can monitor mouse movement or keyboard strokes effectuated by a user. At 804, an activity level is determined based on the monitored interaction. The activity level is determined as either active or inactive (e.g. using analysis component 120). At 806, an advertisement is streamed to the device in response to the activity level being determined as active (e.g. using streaming component). At 808, an advertisement is not streamed to the device in response to the activity level being determined as inactive (e.g. using streaming component 130).

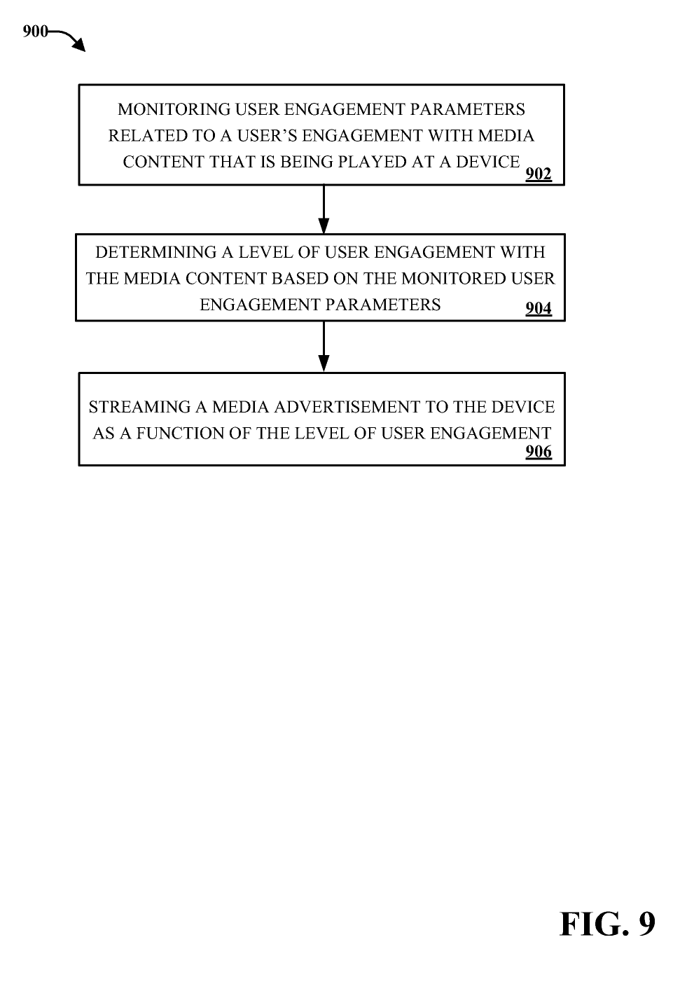

Referring now to FIG. 9, presented is a flow diagram of an example application of systems disclosed in this description accordance with an embodiment. In an aspect, exemplary methodology 900, a media system is stored in a memory and utilizes a processor to execute computer executable instructions to perform functions. At 902, user engagement parameters related to a user's engagement with media content that is being played at a device are monitored (e.g. using monitoring component 110). For example, the monitoring component can monitor at least one of: user interaction with a device at which media content is being played, user interaction with the media content, device context, user physical positioning with respect to the device, user visual direction with respect to the device, device operating parameters, volume of the media content, a size of a player window in which the media content is being played with respect to a graphical user interface of the device, a number of open windows in the graphical user interface of the device, or a location of the player window with respect to other open windows in the graphical user interface of the device. At 904, a level of user engagement with the media content is determined based on the monitored user engagement parameters (e.g. using analysis component 120 and/or inference component 310). At 906, a media advertisement is streamed to the device as a function of the level of user engagement (e.g. using streaming component 130).

In view of the exemplary systems described above, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described in this disclosure. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described in this disclosure, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described in this disclosure, and similarly, storage can be effected across a plurality of devices. Accordingly, the invention is not to be limited to any single embodiment, but rather can be construed in breadth, spirit and scope in accordance with the appended claims.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

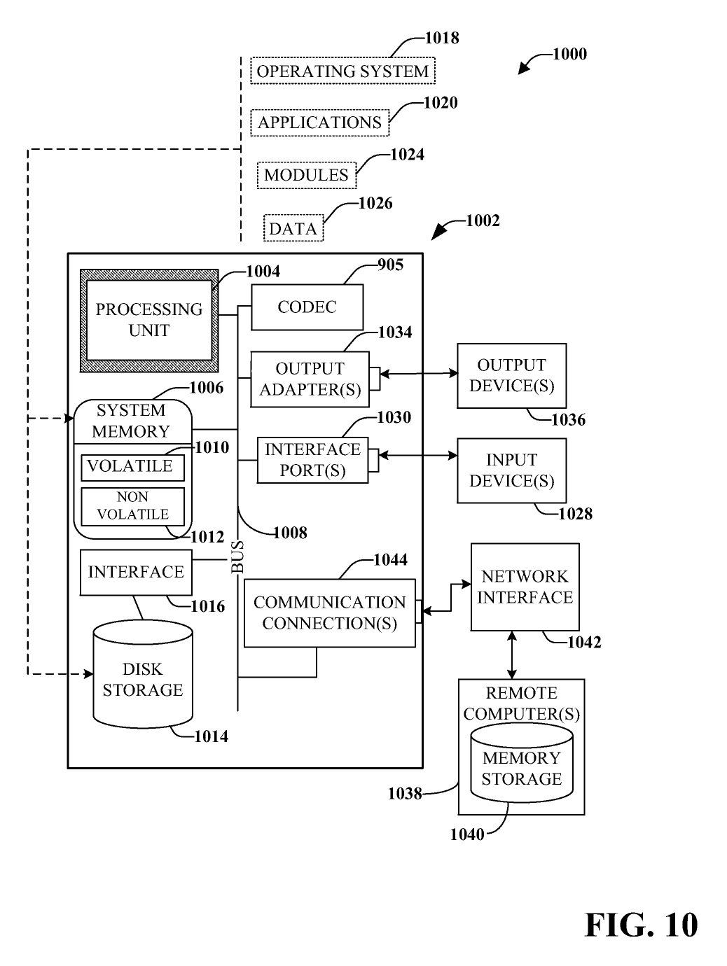

With reference to FIG. 10, a suitable environment 1000 for implementing various aspects of the claimed subject matter includes a computer 1002. The computer 1002 includes a processing unit 1004, a system memory 1006, a codec 1005, and a system bus 1008. In an aspect, processing unit 1004 and system memory 1006 can represent processor 140 and memory 150 respectively. The system bus 1008 couples system components including, but not limited to, the system memory 1006 to the processing unit 1004. The processing unit 1004 can be any of various available processors. Dual microprocessors and other multiprocessor architectures also can be employed as the processing unit 1004.

The system bus 1008 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13104), and Small Computer Systems Interface (SCSI).

The system memory 1006 includes volatile memory 1010 and non-volatile memory 1012. The basic input/output system (BIOS), containing the basic routines to transfer information between elements within the computer 1002, such as during start-up, is stored in non-volatile memory 1012. In addition, according to present innovations, codec 1005 may include at least one of an encoder or decoder, wherein the at least one of an encoder or decoder may consist of hardware, a combination of hardware and software, or software. Although, codec 1005 is depicted as a separate component, codec 1005 may be contained within non-volatile memory 1012. By way of illustration, and not limitation, non-volatile memory 1012 can include read only memory (ROM), programmable ROM (PROM), electrically programmable ROM (EPROM), electrically erasable programmable ROM (EEPROM), or flash memory. Volatile memory 1010 includes random access memory (RAM), which acts as external cache memory. According to present aspects, the volatile memory may store the write operation retry logic (not shown in FIG. 10) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1002 may also include removable/non-removable, volatile/non-volatile computer storage medium. FIG. 10 illustrates, for example, disk storage 1014. Disk storage 1014 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1014 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1014 to the system bus 1008, a removable or non-removable interface is typically used, such as interface 1016.

It is to be appreciated that FIG. 10 describes software that acts as an intermediary between users and the basic computer resources described in the suitable operating environment 1000. Such software includes an operating system 1018. Operating system 1018, which can be stored on disk storage 1014, acts to control and allocate resources of the computer system 1002. Applications 1020 take advantage of the management of resources by operating system 718 through program modules 1024, and program data 1026, such as the boot/shutdown transaction table and the like, stored either in system memory 1006 or on disk storage 1014. It is to be appreciated that the claimed subject matter can be implemented with various operating systems or combinations of operating systems.

A user enters commands or information into the computer 1002 through input device(s) 1028. Input devices 1028 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1004 through the system bus 1008 via interface port(s) 1030. Interface port(s) 1030 include, for example, a serial port, a parallel port, a game port, and a universal serial bus (USB). Output device(s) 1036 use some of the same type of ports as input device(s) 1028. Thus, for example, a USB port may be used to provide input to computer 1002, and to output information from computer 1002 to an output device 1036. Output adapter 1034 is provided to illustrate that there are some output devices 1036 like monitors, speakers, and printers, among other output devices 1036, which require special adapters. The output adapters 1034 include, by way of illustration and not limitation, video and sound cards that provide a means of connection between the output device 1036 and the system bus 1008. It should be noted that other devices and/or systems of devices provide both input and output capabilities such as remote computer(s) 1038.

Computer 1002 can operate in a networked environment using logical connections to one or more remote computers, such as remote computer(s) 1038. The remote computer(s) 1038 can be a personal computer, a server, a router, a network PC, a workstation, a microprocessor based appliance, a peer device, a smart phone, a tablet, or other network node, and typically includes many of the elements described relative to computer 1002. For purposes of brevity, only a memory storage device 1040 is illustrated with remote computer(s) 1038. Remote computer(s) 1038 is logically connected to computer 1002 through a network interface 1042 and then connected via communication connection(s) 1044. Network interface 1042 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1044 refers to the hardware/software employed to connect the network interface 1042 to the bus 1008. While communication connection 1044 is shown for illustrative clarity inside computer 1002, it can also be external to computer 1002. The hardware/software necessary for connection to the network interface 1042 includes, for exemplary purposes only, internal and external technologies such as, modems including regular telephone grade modems, cable modems and DSL modems, ISDN adapters, and wired and wireless Ethernet cards, hubs, and routers.

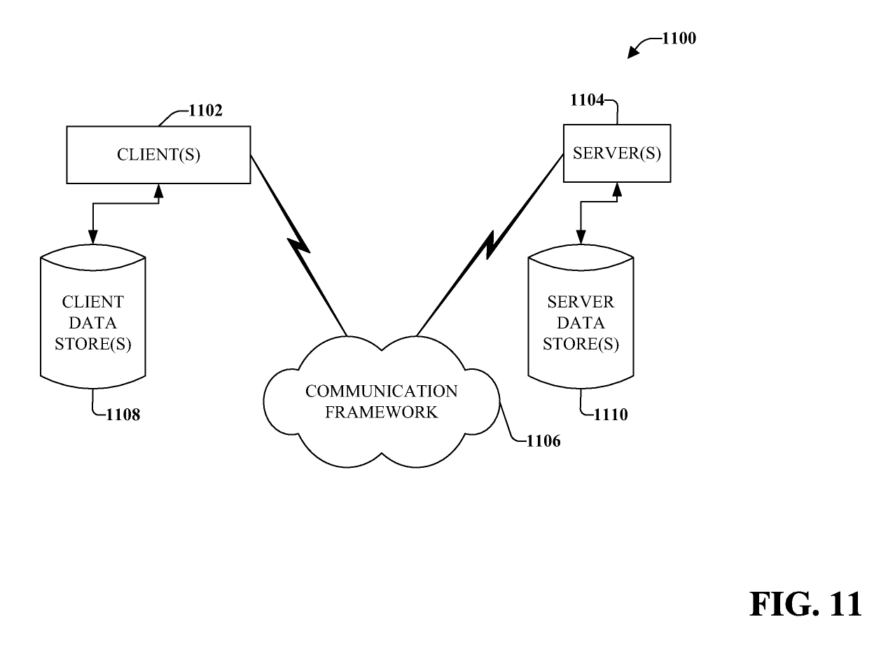

Referring now to FIG. 11, there is illustrated a schematic block diagram of a computing environment 1100 in accordance with this disclosure. The system 1100 includes one or more client(s) 1102 (e.g., laptops, smart phones, PDAs, media players, computers, portable electronic devices, tablets, and the like). System 1100 can for example be employed in connection with implementing one or more of the systems or component described herein show in FIGS. 1-5. The client(s) 1102 can be hardware and/or software (e.g., threads, processes, computing devices). The system 1100 also includes one or more server(s) 1104. The server(s) 1104 can also be hardware or hardware in combination with software (e.g., threads, processes, computing devices). The servers 1104 can house threads to perform transformations by employing aspects of this disclosure, for example. One possible communication between a client 1102 and a server 1104 can be in the form of a data packet transmitted between two or more computer processes wherein the data packet may include video data. The data packet can include metadata, e.g., associated contextual information, for example. The system 1100 includes a communication framework 1106 (e.g., a global communication network such as the Internet, or mobile network(s)) that can be employed to facilitate communications between the client(s) 1102 and the server(s) 1104.

Communications can be facilitated via a wired (including optical fiber) and/or wireless technology. The client(s) 1102 include or are operatively connected to one or more client data store(s) 1108 that can be employed to store information local to the client(s) 1102 (e.g., associated contextual information). Similarly, the server(s) 1104 are operatively include or are operatively connected to one or more server data store(s) 1110 that can be employed to store information local to the servers 1104.

In one embodiment, a client 1102 can transfer an encoded file, in accordance with the disclosed subject matter, to server 1104. Server 1104 can store the file, decode the file, or transmit the file to another client 1102. It is to be appreciated, that a client 1102 can also transfer uncompressed file to a server 1104 and server 1104 can compress the file in accordance with the disclosed subject matter. Likewise, server 1104 can encode video information and transmit the information via communication framework 1106 to one or more clients 1102.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

1. A system comprising:
a memory; and
a processor, coupled to the memory, configured to:
detect a plurality of user interactions with a device at which media content is being played via a graphical user interface (GUI) displayed using the device, each user interaction having a specified type;
generate a score comprising a sum of weighted values for each of the detected plurality of user interactions, each type of user interaction having an associated weight;
determine a level of user engagement with the media content from a plurality of predetermined levels of user engagement, each of the predetermined levels of user engagement corresponding to a range of values of the generated score;
transmit a stream of a media advertisement to the device, responsive to the determined level of user engagement corresponding to a first level of the plurality of predetermined levels of user engagement; and
stop transmission of the stream of the media advertisement to the device prior to completion of the media advertisement, responsive to subsequently determining that a second generated score for a detected second plurality of user interactions with the device during playback of the media advertisement corresponds to a second level of the plurality of predetermined levels of user engagement.

2.

3. The system of claim 1, wherein the processor is further configured to present a prompt to continue playing the advertisement or skip the advertisement, after stopping transmission of the advertisement.

4. (canceled)

5. The system of claim 1, wherein the processor is further configured to detect the plurality of user interactions or detect the second plurality of user interactions by detecting movement of a mouse or cursor or clicking of a mouse or cursor.

6. The system of claim 1, wherein the processor is further configured to detect the plurality of user interactions or detect the second plurality of user interactions by detecting keystrokes.

7. The system of claim 1, wherein the plurality of predetermined levels of user engagement consist of active or inactive; and
wherein the processor is configured to transmit the stream of the media advertisement to the device responsive to the determined level of user engagement being active, and stop transmission of the stream of the media advertisement to the device responsive to the determined second level of user engagement being inactive.

8. The system of claim 1, wherein the processing device is further to store determined information indicating user interaction with the device at which the media content is being played.

9. The system of claim 8, wherein the processing device is further to replace old determined information indicating user interaction with new determined information indicating user interaction in storage and generates a timestamp indicating a time of last event of user interaction.

10. The system of claim 1, wherein the processor is further configured to select the media advertisement to transmit to the device from a plurality of media advertisements responsive to the generated score exceeding a predetermined threshold.

11. The system of claim 1, wherein the processing device is further to dynamically increase a size, visual depth, or audio volume associated with playing of the media advertisement at the device responsive to the generated score being below a predetermined threshold.

12. (canceled)

13. (canceled)

14. The system of claim 1, wherein the user engagement parameters comprise: user interaction with the media content, device context, user physical positioning with respect to the device, user visual direction with respect to the device, device operating parameters, volume of the media content, a size of a player window in which the media content is being played with respect to a graphical user interface of the device, a number of open windows in the graphical user interface of the device, or a location of the player window with respect to other open windows in the graphical user interface of the device.

15. (canceled)

16. (canceled)

17. (canceled)

18. (canceled)

19. (canceled)

20. (canceled)

21. A method comprising:
detecting a plurality of user interactions with a device at which media content is being played via a graphical user interface (GUI) displayed using the device, each detected user interaction having a corresponding time;
filtering the detected plurality of user interactions according to a predetermined temporal resolution to extract a subset of the plurality of user interactions;
determining, for each of a plurality of consecutive predetermined time periods, whether a user interaction of the subset of the plurality of user interactions has a corresponding time within said predetermined time period;
identifying, by the processing device, a level of user engagement with the media content from a plurality of predetermined levels of user engagement based on the presence of user interactions of the subset of plurality of user interactions in each of the plurality of consecutive predetermined time periods;
transmitting a stream of an advertisement as a function of the level of user engagement; and
stopping transmission of the stream of the media advertisement to the device prior to a timeframe indicator of the media advertisement responsive to the level of the user engagement subsequently falling below a determined threshold.

22. (canceled)

23. (canceled)

24. (canceled)

25. The method of claim 21, wherein detecting the user interaction comprises detecting movement of a mouse or cursor having a velocity above a predetermined threshold.

26. The method of claim 21, wherein detecting the user interaction comprises monitoring keystrokes.

27. The method of claim 21, wherein detecting the user interaction comprises intercepting hardware or software interrupt signals.

28. The method of claim 21, wherein determining the level of user engagement further comprises determining whether the user is either active or inactive, and wherein:
transmitting the stream of the media advertisement to the device is performed in response to the determining the user is active; and
stopping transmission of the stream of the media advertisement to the device is performed in response to subsequently determining the user is inactive.

29. The method of claim 21, further comprising:
storing the determined information indicating the user interaction with the device at which the media content is being played.

30. The method of claim 29, further comprising:
replacing old determined information indicating user interaction with new the monitored information with indicating user interaction in storage; and
generating a timestamp indicating a time of a last event of user interaction.

31. (canceled)

32. (canceled)

33. (canceled)

34. (canceled)

35. The method of claim 21, further comprising:
selecting the media advertisement to stream to the device from a plurality of media advertisements as function of at least one of user interaction with the media content, device context, user physical positioning with respect to the device, user visual direction with respect to the device, device operating parameters, volume of the media content, a size of a player window in which the media content is being played with respect to a graphical user interface of the device, a number of open windows in the graphical user interface of the device, or a location of the player window with respect to other open windows in the graphical user interface of the device.

36. The method of claim 21, further comprising:
dynamically increasing a size, visual depth, or audio volume associated with playing of the media advertisement at the device responsive to the level of user engagement being below a threshold.

37. (canceled)

38. (canceled)

39. (canceled)

40. (canceled)

41. (canceled)

42. (canceled)
